(19) United States
(12) Patent Application Publication
(10) Pub. No.: US 2025/0313407 A1
(43) Pub. Date: Oct. 9, 2025

(54) RESTOCKING ROBOT

(71) Applicant: Emancro Robotics Corp., Berkeley, CA (US)

(72) Inventors: Frederik Ebert, Berkeley, CA (US); Donglei Cal, Berkeley, CA (US)

(21) Appl. No.: 18/627,128

(22) Filed: Apr. 4, 2024

Related U.S. Application Data
(60) Provisional application No. 63/521,053, filed on Jun. 14, 2023.

(51) Int. Cl. B65G 1/137; A47B 67/02; B25J 5/00; B25J 15/00; B25J 15/06; B65G 1/02

(52) U.S. Cl. CPC B65G 1/1371; B25J 5/007; B65G 1/026; A47B 67/02; B25J 15/0028; B25J 15/0616; B65G 2203/0216; B65G 2203/041; B65G 2203/046

(57) ABSTRACT

In some examples, a restocking robot comprises a mobile base controllable to navigate to an inventory unit at a restocking location, a robot cabinet supported by the mobile base, the robot cabinet including a receptacle for holding a restocking item for the inventory unit. A robot arm is controllable to engage with and open the receptacle of the robot cabinet and retrieve therefrom a restocking item for restocking the inventory unit. The robot arm includes an end effector mounted to the robot arm. The end effector is controllable to move the restocking item retrieved from the receptacle of the robot cabinet into the inventory unit at the restocking location.

### CLAIM OF PRIORITY

This patent application claims the benefit of priority, under 35 U.S.C. Section 119(e), to Ebert et al, U.S. Provisional Patent Application Ser. No. 63/521,053, entitled “RESTOCKING ROBOT,” filed on Jun. 14, 2023 (Attorney Docket No. 6244.001PRV), which is hereby incorporated by reference herein in its entirety.

### TECHNICAL FIELD

Examples in this application relate to a multi-purpose robotic system that can be used in a variety of ways to restock inventory. Some examples of the robotic system include an automated mobile restocking robot for restocking medical supplies and medication in a hospital or medical center. The supplies may be stored in a medication cabinet or tray. In some examples, a cabinet drawer or a medication tray can be manipulated by the restocking robot to be resupplied.

### BACKGROUND

Restocking medical supplies in a hospital can be a very labor intensive task. The medical supplies may be stored in medication cabinets or medical tray assemblies sometimes randomly and remotely located in nursing units and operating rooms. Medication cabinets located in operating rooms are often referred to as anesthesia stations since they primarily contain substances used for anesthetizing patients. For a mid-sized four hundred bed hospital for example, restocking medical supplies and medications may take one hundred and sixty hours a week. Additionally, a manual recounting of medications, especially of controlled substances such as opioids, can also be labor intensive adding another sixty hours per week of manual time. Errors in medication distribution and restocking can increase risk of wrong medication administration which can have fatal consequences. Hospitals can experience great difficulty in recruiting staff in this regard, especially during a pandemic when availability of staff might be significantly impacted.

Conventionally, Automatic Dispensing Cabinets (ADCs) keep track of fill-levels, also called Periodic Automatic Replenishment (PAR) levels. PAR levels may include minimum and maximum quantity limits that can be set for a given item of medication or a stock unit. Based on a given PAR level, when an ADC detects a quantity of the given item is too low, the ADC sends a refill-request to a central pharmacy based in the hospital or medical center.

In the central pharmacy, technicians pull the necessary medications from a central medication storage, sometimes also referred to as a carousel system, and typically insert these medications into plastic bags or pouches labeled with the type of medication, destination, and other pertinent details and place the bags or pouches into carts ready for distribution in the hospital. In some instances, pharmacy technicians also manually refill patient-specific boxes in the medication rooms. In any event, such manual restocking is conventionally very error prone since it can happen frequently (sometimes several times a day) that technicians inadvertently place items into the wrong bags, or add incorrectly marked labels. Routinely, a pharmacy technician picks up the carts and distributes medication items to all ADCs in the hospital. This distribution multiplies and spreads any errors.

These medication restocking difficulties and errors can be even more challenging when one considers that inventory can be scattered throughout the hospital and that medication expires quickly when medication cabinets can only store a limited variety of medication at small local levels of inventory. Moreover, theft of medication and supplies is also a major problem in hospitals. Medical supplies typically require much space for storage, yet hospitals are very short on space and existing storerooms are often packed with medical equipment.

### SUMMARY

In some examples, a restocking robot and associated controller system are provided for restocking applications. In some more particular examples, a mobile restocking robot for restocking a medication cabinet includes at least one robot arm that can, in at least one capability, open an ADC drawer and move medication into the drawer or out of the ADC drawer. In some examples, the robot arm is height adjustable.

In some examples, the medication and/or medical supplies are supplied by a carousel which can be manipulated by the restocking robot to retrieve medication and medical supplies stored and inventoried at the carousel. In some examples, the restocking robot has the ability to communicate with the ADC and/or carousel to authenticate and/or update quantities of items and other data.

In some examples, the restocking robot can move or relocate an ADC drawer or other drawer, such as a robot drawer, from a support such as a table or bench, onto another table or bench. In some examples, the restocking robot can pick up and handle an entire ADC drawer. In some examples, a robot drawer is provided with pockets. In some examples, a pocket in the robot drawer has a lid. In some examples, the restocking robot can manipulate the lid to place items in a pocket. In some examples, the restocking robot can relocate bins of items, and/or medication trays, and/or other transport platforms or items. In some examples, the restocking robot can pick up, place onto, or put into bins or boxes from tables, shelves, and carousels. In some broad examples, the restocking robot identifies, interacts with, and/or utilizes any flat surface to retrieve boxes from or place boxes onto.

In some examples, the robot arm of the restocking robot includes an end effector. In some examples, the robot end effector is equipped with multiple suction cups of potentially different sizes. The suction cups are optionally moveable, allowing them to retract using only certain suction cups at a time. In some examples, when an object is held by a suction cup, pressure sensors can detect, through a fall in vacuum pressure, if the object is removed from the suction cup, for example by theft or unauthorized removal, or by an inadvertent bump against an obstruction, for example. In some examples, the robot end effector is equipped with one or multiple prehensile grippers, such as parallel jaw grippers.

In some examples, the restocking robot is equipped with a bar-code or Radio Frequency Identification (RFID) scanner.

In some examples, the restocking robot includes cameras to detect if an unauthorized person is trying to remove medication from the robot.

In some examples, a restocking robot comprises a mobile base controllable to navigate to an inventory unit at a restocking location; a robot cabinet supported by the mobile base, the robot cabinet including a receptacle for holding a restocking item for the inventory unit; a robot arm controllable to engage with and open the receptacle of the robot cabinet and retrieve therefrom a restocking item for restocking the inventory unit; and the robot arm including an end effector mounted to the robot arm, wherein the end effector is controllable to move the restocking item retrieved from the receptacle of the robot cabinet into the inventory unit at the restocking location.

In some examples, the receptacle in the robot cabinet includes a robot drawer movable in the robot cabinet to be opened and closed by the restocking robot.

In some examples, the restocking robot further comprises a vertical linear actuator supported by the mobile base. In some examples, the robot arm is supported by the vertical linear actuator.

In some examples, the mobile base is motorized and includes a sensor for localization and navigation of the restocking robot to the inventory unit at the restocking location.

In some examples, the end effector includes an array of robot fingers and/or a prehensile gripper controllable to grasp the restocking item.

In some examples, the robot arm comprises a series of interconnected links, wherein a base link of the robot arm is connected to the vertical linear actuator, and wherein each link of the robot arm is controllable either to rotate about a longitudinal axis of the link with respect to an adjacent or another link in the robot arm, or to adjust a relative or angular position of the link with respect to an adjacent or another link in the robot arm.

In some examples, the array of robot fingers includes at least one robot finger provided with a suction cup to hold, under application of a vacuum, the restocking item.

In some examples, the inventory unit comprises a medication cabinet including a medication cabinet drawer, and wherein the robot arm is controllable to open and close the medication cabinet drawer.

In some examples, the robot arm is controllable to move the retrieved restocking item to a medication cabinet drawer prior opened by the robot arm.

In some examples, the medication cabinet drawer includes a pocket, the pocket associated with a specific restocking item, and wherein the robot arm is controllable to restock the pocket with the specific restocking item associated with the pocket.

In some examples, the medication cabinet is assigned as a navigation target for the mobile base of the restocking robot.

In some examples, the prehensile gripper includes a parallel jaw gripper including a pair of retractable tweezers.

In some examples, at least one suction cup provided on the array of robot fingers is sized to fit between pills in a blister pack.

In some examples, the robot cabinet is removable from the restocking robot, and wherein the robot arm is further controllable to place the removable robot cabinet on a support surface adjacent the restocking robot.

In some examples, the restocking robot further comprises at least one scanning camera to scan or identify one or more of a barcode, a labelled medication, an item of medical supply, an expiry date, or another item of data borne on the restocking item.

In some examples, the at least one scanning camera is mounted on a camera beam, the camera beam being adjustable to reposition the at least one scanning camera to adjust a scanning zone of the at least one camera.

In some examples, the at least one scanning camera includes an array of scanning cameras defining at least one scanning zone for the restocking robot.

In some examples, the at least one scanning zone includes overlapping fields of view of the at least one scanning camera.

In some examples, the restocking robot further comprises an actuator to transfer or slide the robot cabinet from a transport position on the mobile base to a restocking position of the robot cabinet on a table or bench.

In some examples, the restocking robot further comprises a transition flap to support an item pulled by the restocking robot from a shelf, carousel, or a table. In some examples, the transition flap is foldable under autonomous action of the robot arm, or under the action of one more multiple actuators. In some examples, the transition flap is extendible under autonomous action of the robot arm, or self-extendible under action of a motor. In some examples, the transition flap is mounted on a vertical linear actuator and is controllable to adjust a vertical height of the transition flap.

In some examples, a method of restocking an inventory unit is provided. An example method includes providing a restocking robot, the restocking robot comprising: a mobile base controllable to navigate to the inventory unit at a restocking location; a robot cabinet supported by the mobile base, the robot cabinet including a receptacle; a robot arm controllable to engage with and open the receptacle of the robot cabinet and retrieve therefrom a restocking item for restocking the inventory unit; and the robot arm including an end effector controllable to move the restocking item retrieved from the receptacle of the robot cabinet into the inventory unit at the restocking location; directing or configuring the restocking robot to move to the restocking location; and directing or configuring the end effector to move the retrieved restocking item into the inventory unit.

In some examples, a further method of restocking an inventory unit is provided. An example method comprises providing a restocking robot, the restocking robot including a mobile base, a robot arm, an end effector, and a robot drawer included in a robot cabinet supported on the mobile base; directing or configuring the restocking robot to navigate to a carousel system supplying items of medication or medical supply; directing or configuring the restocking robot to pull a bin containing an item of medication or medical supply from the carousel system; directing or configuring the restocking robot to take a desired quantity of the item of medication or medical supply from the bin and place the desired quantity of the item of medication or medical supply into the robot drawer; directing or configuring the restocking robot to close or load the robot drawer into the robot cabinet; directing or configuring the restocking robot to navigate along a restocking route to the inventory unit; directing or configuring the restocking robot to log into or authenticate with the inventory unit; directing or configuring the restocking robot to open or a drawer of the inventory unit; and directing or configuring the restocking robot to restock the drawer of the inventory unit with the desired quantity of the item of medication or medical supply.

In some examples, a method of restocking medication trays is provided. An example method comprises providing a restocking robot, the restocking robot including a mobile base, a robot arm, an end effector, a scanning camera, a transition flap, and a robot drawer included in a robot cabinet supported on the mobile base; receiving a request to restock a medication tray carried in a medication tray cart; moving the restocking robot adjacent the medication tray cart; directing the restocking robot to pull the medication tray onto the transition flap of the restocking robot; directing the restocking robot to place the pulled medication tray into an RFID scanning device; directing the RFID scanning device to scan contents of the medication tray placed therein; after RFID scanning, directing the restocking robot to remove the medication tray from the RFID scanning device; directing the scanning camera of the restocking robot to take a picture of the contents of the medication tray to generate tray content data; analyzing, by a trained AI-model, the tray content data to determine an identity of items in the contents of the medication tray; based at least on the received restock request, combining data generated by the RFID scanning and trained AI-model analysis to determine items missing from or incorrectly present on the medication tray; directing the restocking robot to add missing items to the medication tray, or remove items incorrectly present on the medication tray; and directing the restocking robot to place the medication tray back into the medication tray cart.

In some examples, a robotic restocking system includes a mobile platform capable of autonomous navigation to designated inventory stations, an integrated storage unit for holding items intended for restocking, and a robotic manipulator arm equipped with a versatile end effector designed to retrieve items from the storage unit and deposit them into the inventory stations.

In some examples, a robotic inventory management system features a self-propelled base, a detachable modular cabinet with compartments for various restocking items, and a multi-jointed robotic limb that can interact with both the modular cabinet and inventory units to facilitate the restocking process.

In some examples, an automated restocking apparatus consists of a motorized chassis for movement within a facility, a receptacle structure mounted on the chassis for carrying restocking materials, and an articulating appendage capable of precise movements to transfer materials from the receptacle structure to specified restocking points.

In some examples, a robotic restocking unit is equipped with a navigational base, a series of interchangeable drawers for storing inventory items, and a robotic armature with an adaptive gripping mechanism that can selectively open the drawers and restock items into corresponding inventory slots.

In some examples, a robotic supply replenishment system includes a guided vehicular base, a storage assembly for inventory items, and a robotic extension with a configurable end effector that can perform various tasks including opening and closing of inventory receptacles and transferring items to and from the storage assembly.

In some examples, an autonomous restocking robot features a locomotive base with onboard sensors for pathfinding, a cabinet with specialized storage for inventory items, and a robotic arm with a multi-functional end effector capable of manipulating objects and interfacing with inventory management systems.

In some examples, a robotic restocking device comprises a mobile support structure, a series of storage units for holding various items, and a robotic arm with a suction-based end effector designed to handle items of different sizes and shapes for the purpose of restocking.

In some examples, a robotic restocking mechanism includes a self-navigating base unit, a storage compartment with multiple drawers for segregating inventory items, and a robotic arm with an end effector that includes retractable tweezers for handling small and delicate items.

In some examples, a robotic restocking entity is provided with a powered base for autonomous movement, a storage facility with designated compartments for different restocking items, and a robotic arm with an end effector that employs both suction cups and prehensile grippers for versatile item manipulation.

In some examples, a robotic restocking machine includes a mobile base with localization capabilities, a storage system with various receptacles for inventory items, and a robotic arm with an end effector that integrates scanning technology for item identification and verification during the restocking process.

In some examples, a method for automated restocking involves the deployment of a robotic system that navigates to inventory locations, retrieves items from an onboard storage unit, and systematically restocks the items into designated inventory units using a robotic arm with a multi-purpose end effector.

In some examples, a method for replenishing inventory utilizes a robotic apparatus with a mobile base to transport restocking items to inventory stations, where a robotic arm with an adaptable end effector performs the restocking of items according to predetermined inventory requirements.

In some examples, a method for managing inventory restocking is disclosed, through the use of an autonomous robot that carries a modular cabinet with restocking items, navigates to inventory units, and employs a robotic arm to transfer items from the cabinet to the inventory units.

In some examples, a method for conducting restocking operations with a robotic system that autonomously moves to restocking locations, utilizes a robotic arm to access a storage assembly, and places restocking items into inventory units using an end effector designed for precise item handling.

In some examples, a method for automated inventory management involves a robotic restocking unit that navigates to designated locations, interacts with a storage assembly to retrieve items, and uses a robotic arm with a versatile end effector to restock inventory units.

In some examples, a method for replenishing supplies in inventory units uses a robotic restocking device that autonomously navigates within a facility, carries a storage compartment with restocking items, and employs a robotic arm with a multi-functional end effector to perform restocking tasks.

In some examples, a method for restocking inventory utilizes a robotic entity that moves to inventory stations, retrieves items from a storage facility using a robotic arm with a suction-based end effector, and restocks the inventory units with the retrieved items.

In some examples, a method for automated restocking of inventory units employs a robotic mechanism with a self-navigating base, a storage compartment with drawers, and a robotic arm with an end effector that includes retractable tweezers for handling small items during restocking.

In some examples, a method for restocking inventory using a robotic machine navigates to restocking locations, carries a storage system with designated compartments, and utilizes a robotic arm with an end effector that integrates scanning technology for item verification during restocking.

In some examples, a method for autonomous restocking involves a robotic system that navigates to inventory units, employs a robotic arm to access a storage facility with various receptacles, and uses an end effector to transfer items to the inventory units while ensuring item accuracy through integrated scanning.

These and other features are described without limitation more fully below.

### BRIEF DESCRIPTION OF THE DRAWINGS

FIG. 1 is a schematic view of a restocking robot and associated components, in accordance with some example embodiments.

FIG. 2 is a further schematic view of a restocking robot and associated components, in accordance with some example embodiments.

FIG. 3 is a further schematic view of a restocking robot and associated components, in accordance with some example embodiments.

FIG. 4 is a further schematic view of a restocking robot and associated components, in accordance with some example embodiments.

FIGS. 5A-5B include schematic views of a portion of a robot arm with a multi-finger end effector, in accordance with some example embodiments.

FIGS. 6A-6B include schematic views of retracting tweezers integrated into a parallel jaw gripper, in accordance with some example embodiments.

FIG. 7 is a further schematic view of a restocking robot and associated components, in accordance with some example embodiments.

FIG. 8 illustrates a high level flow-chart of a method of restocking an inventory unit, in accordance with an example method.

FIG. 9 illustrates a software architecture, in accordance with an example embodiment.

FIGS. 10A-10H include pictorial views of a restocking robot, in accordance with some example embodiments.

FIGS. 11A-11E include pictorial views of some components of a restocking robot, in accordance with some example embodiments.

FIG. 12 is a further schematic view of a restocking robot and associated components, in accordance with some example embodiments.

FIG. 13 is a further schematic view of a restocking robot and associated components, in accordance with some example embodiments.

FIG. 14 illustrates a high level flow-chart of a method of restocking medication trays, in accordance with an example method.

FIGS. 15A-15B include pictorial views of a two-arm version of an example restocking robot.

FIG. 16 is a pictorial view of an example two-arm restocking robot with example top rotary drawers opened in an extended position.

FIGS. 17A-17C include pictorial views of an example barcode scanner incorporating a transparent conveyor belt for use in an example restocking robot.

### DETAILED DESCRIPTION

As mentioned above, an inventory unit, such as an automatic dispensing cabinet (ADC) can monitor fill-levels, also called Periodic Automatic Replenishment (PAR) levels. PAR levels may include minimum and maximum quantity limits that can be set for a given item of medication or a stock unit. Based on a given PAR level, when an ADC detects a quantity of the given item is too low, the ADC sends a refill-request to a central pharmacy based in the hospital or medical center. In some examples herein, a mobile medication restocking robot responds to and fulfils this request, instead of a human operator or pharmacy technician for example.

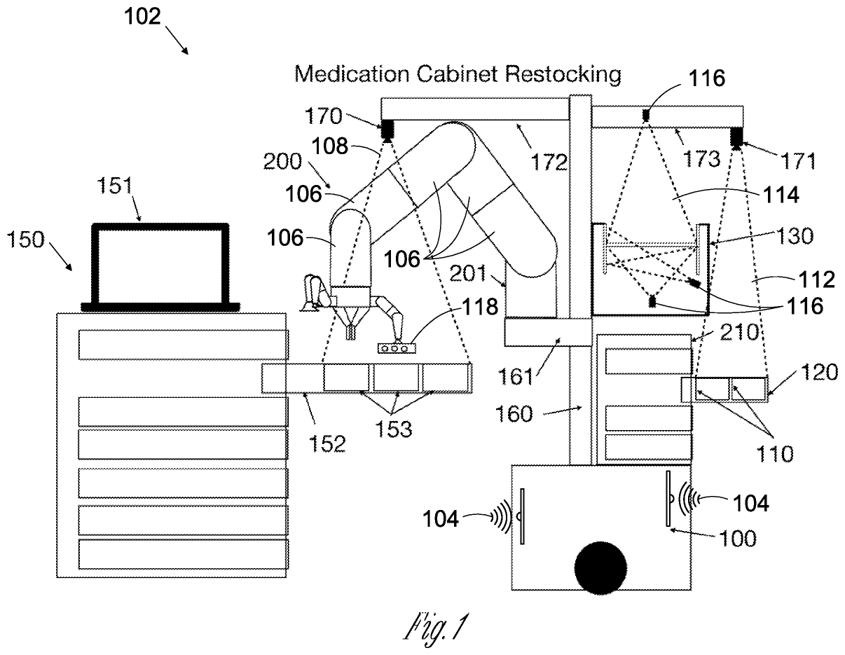

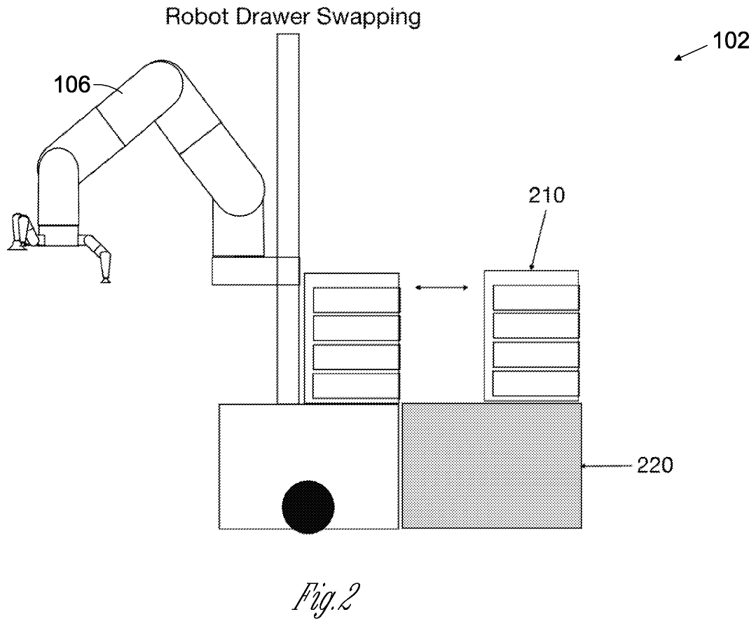

With reference to FIG. 1 and FIG. 2, a mobile restocking robot 102 for restocking medication and medical supplies in a hospital or medical center, for example, is provided. Other restocking applications are possible, for example in a shop or factory. The restocking robot 102 includes a mobile base 100. The mobile base 100 is motorized and equipped with sensors (e.g. laser scanners 104) for localization and navigation.

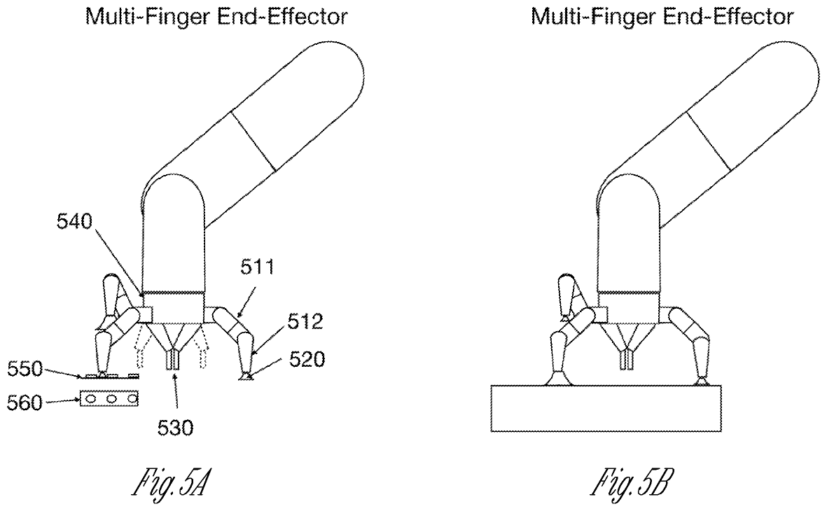

The restocking robot 102 includes at least one robot arm 200. The robot arm 200 is vertically adjustable via a vertical linear actuator 160 mounted on the mobile base 100. The robot arm 200 includes a series of interconnected links 106. Each link 106 can be controlled to rotate about a longitudinal axis of the link 106 with respect to an adjacent or another link 106 in the robot arm 200. In present examples, a longitudinal axis of a link 106 may be considered to be an imaginary line running down the center of the link 106 perpendicular to a transverse plane of the link 106 and around which rotations of the link 106 in the transverse plane may occur. Each link 106 can also be controlled to adjust a relative or angular position of the link 106 with respect to an adjacent or another link 106 in the robot arm 200. The robot arm 200 of the restocking robot 102 may include end effectors described more fully below. A series of controlled rotations or angular movements of each or several links 106 in the robot arm 200 can move an end effector (see for example FIG. 5) of the restocking robot 102 to a desired restocking location, for example adjacent an inventory unit such as a medication cabinet 150 or an ADC to engage with and open and/or close a drawer of the medication cabinet or ADC as described further below. A base link 201 of the robot arm 200 is mounted to the carriage 161 of the linear actuator 160.

In some examples, the robot arm 200 of the restocking robot 102 is controllable to engage with, open, and/or close a receptacle or drawer 152 of a medication cabinet 150. An example open position of the drawer 152 is shown in FIG. 1. In some examples, the robot arm 200 of the restocking robot 102 is controllable to engage with, open, and/or close a receptacle such as a robot drawer 120 of a robot cabinet 210. An example open position of the drawer 120 as shown in FIG. 1. In other examples (not shown in FIG. 1), the robot arm 200 of the restocking robot 102 is controllable to engage with, open, and/or close a drawer of an ADC or a supply carousel.

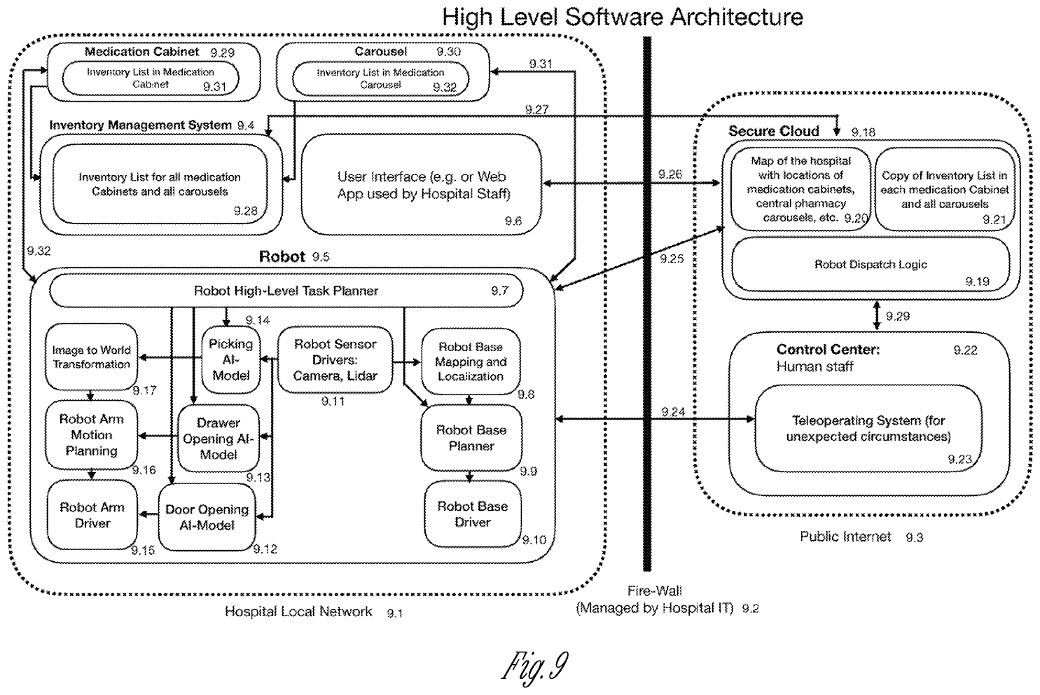

The medication cabinet 150 includes a computer terminal 151 operated by pharmacy personnel. For example, technicians and nurses can log into the computer terminal 151 to open cabinet drawers, and update medication quantities. The restocking robot 102 may be controlled by an onboard computer or controller, or by a remote controller. The onboard computer or controller of the restocking robot 102 may communicate with a computer or controller of an ADC. The onboard or remote controller may be connected to a hospital local network, for example as shown in FIG. 9.

The restocking robot 102 includes scanning cameras, for example one or more of scanning cameras 116, 170 and 171, to scan or identify a barcode, or a labelled medication, an item of medical supply, an expiry date, and/or other items of data, for example by means of scanning a barcode placed on an item of medication or packaging. Scanned data may be compared to data stored in lookup tables in a database for authorization, checking, and verification purposes. In the illustrated example, the restocking robot 102 is equipped with two cameras (for example RGB-D depth cameras) 170 and 171 attached to respective camera beams 172 and 173. In some examples, the camera beams 172 and 173 can extend and retract, e.g. using a linear actuator to establish different scanning zones. For example, the camera 170 and camera beam 172 can be controlled and arranged to establish a first scanning zone 108 (shown by triangular dotted outline, merely by way of example) overlooking pockets 153 in an opened drawer 152 of a medication cabinet 150. The camera 170 can also monitor and scan a restocking item in the scanning zone 108 such as a medication 118 (or other item of medical supply) held by an end effector 540 of the restocking robot 102. Example end effectors are discussed further below in connection with FIG. 5.

In further capability, the camera 171 and camera beam 173 can be controlled and arranged to establish a second scanning zone 112 (again shown by a triangular dotted outline, merely by way of example) overlooking pockets 110 in a drawer 120 of a robot cabinet 210 located on the mobile base 100. The camera 171 can also monitor and scan items in the scanning zone 112 such as a pocket 110 (or other item of medical supply) held by the end effector 540 of the restocking robot 102.

In some examples, the cameras 170 and 171 can scan and capture data from items already located inside or about to be placed into or withdrawn from the cabinet drawer 152 and/or the internal pockets 153 of the cabinet drawer 152. In some examples, the cameras 170 and 171 can scan and capture data from items already located inside or about to be placed into or withdrawn from the robot drawer 120 and/or the internal pockets 110 of the robot drawer 120.

In further capability, a third scanning zone 114 is provided in a scanner 130 of the restocking robot 102. The scanner 130 may have enclosed sides as shown or be defined by a table or other arrangement. The third scanning zone 114 is defined by an array of three scanning cameras 116 that have overlapping views as shown and can scan items held in the scanning zone 114 to identify items placed therein. Other numbers and configurations of the scanning cameras 116 are possible. For example, two scanning cameras 116 may suffice to provide an overlapping field of view. More scanning cameras 116, for example six scanning cameras 116 may provide a more detailed field of view, as desired. Scannable items in the scanning zone 114 may include labelled medications, medical supplies, expiry dates, and other items of data, for example by means of scanning a barcode placed on an item of medication or packaging. Scanned data may be compared to data stored in lookup tables in a database for authorization, checking, and verification purposes. Items may be introduced into the third scanning zone 114 for scanning, checking and/or identification by the robot arm 200 and manipulated therein for viewing by end effector 540. The provision of three overlapping views by the scanning cameras 116 in the scanning zone 114 to view and interrogate an item held or manipulated therein can improve the reliability and accuracy of scanning “hits” if these items.

As shown, a scanning zone 108, and/or scanning zone 112, and/or scanning zone 114 may include in its field of view an opened drawer 152 of a medication cabinet, or in some examples an opened drawer of an ADC or supply carousel, or in some examples an opened drawer 120 of a robot cabinet 210.

In some examples, the arm 200 of the restocking robot 102 is controllable to engage with and withdraw a drawer 152 entirely from a medication cabinet 150 and place the drawer 152 onto a bench or table, or other flat surface. In some examples, the arm 200 of the restocking robot 102 is controllable to engage with and withdraw a drawer entirely from an ADC or a supply carousel and place the ADC or supply carousel drawer onto a bench or table, or other flat surface. In some examples, the arm 200 of the restocking robot 102 is controllable to engage with and withdraw entirely a robot drawer 120 from a robot cabinet 210 and place the robot drawer 120 onto a bench or table, or other flat surface. In some examples, an opened drawer of a respective medication cabinet, ADC, supply carousel, or robot cabinet is scanned when fully withdrawn and placed on the bench or table, or other flat surface.

With reference to FIG. 2, in some examples, the arm 200 of the restocking robot 102 is controllable to transfer or slide the robot cabinet 210 from a transport position on the mobile base 100 into a restocking position on an adjacent table or bench 220 (or other flat surface), as shown. In some examples, the restocking robot 102 includes an actuator to transfer or slide a robot cabinet 210 from the transport position on the mobile base 100 into the restocking position on the adjacent table or bench 220 or other flat surface, as shown. In some examples, the restocking robot 102 is controllable, as part of a restocking operation, to swap out an entire robot cabinet 210.

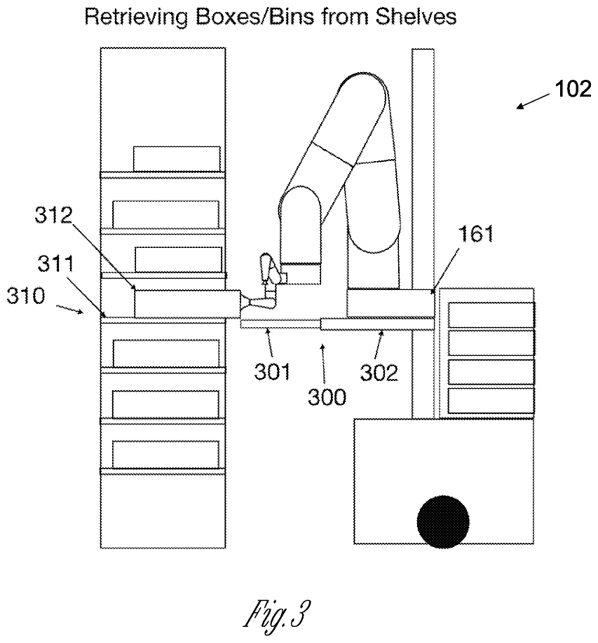

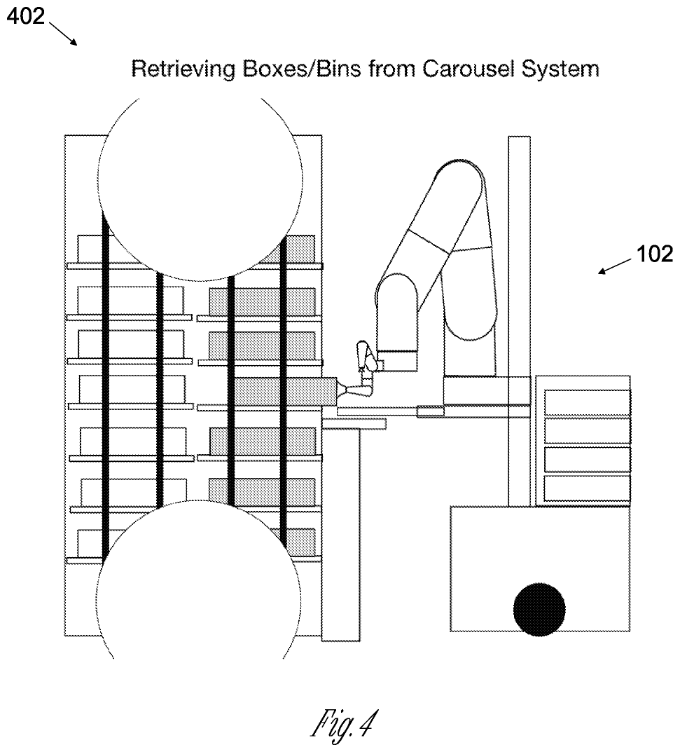

With reference to FIG. 3 and FIG. 4, in some restocking applications the restocking robot 102 is required to take or transport a box or other large object from a shelf or a table, or place the large object on a shelf or table. Picking up a large object with one arm alone, for example by the robot arm 200 described above, may be very difficult or even impossible. To address this situation, in some examples, the manipulation or movement of large items is facilitated. To this end, the restocking robot 102 is equipped with a transition flap 300. The function of the transition flap 300 is to support boxes or other large items when pulling them from shelves, carousels, or a table. The transition flap 300 may include, for example, one or more metal plates that can fold and unfold in multiple sections and/or extend linearly, for example as shown by the telescoping sections 301 and 302 of the flap 300 illustrated in FIG. 3 and FIG. 4. When the restocking robot 102 is required to pick up a box or large item from a shelf or table, the restocking robot 102 can pull the box or large item onto the extended (or unfolded) transition flap 300 using its robot arm 200 and end effector 540. The robot arm 200 and end effector 540 can also push the object back into the shelf or onto a table from the transition flap 300.

In some examples, the transition flap 300 is mounted on the vertical linear actuator 160 allowing the restocking robot 102 to adjust the vertical height of the transition flap 300. Since all of these components are mounted on the mobile base 100, the restocking robot 102 can move to any shelf or table and pick up objects from any level. In some examples, the robot arm 200 of the restocking robot 102 is able to fold and unfold the transition flap 300, potentially providing a more cost-effective version of the restocking robot 102 in that the need for transition flap extension motors and sensors may be unnecessary.

As shown in FIG. 3, once the restocking robot 102 arrives in front of a shelf, it can extend or unfold the transition flap 300 to provide support for the item being removed from the shelf. In the illustrated example, the sections 301 and 302 are comprised by two plates in which plate 301 can retract into or alongside the plate 302. In a folding version of the transition flap 300, the plates 301 and 302 are connected via hinge-joint. The plate 302 is connected to the linear actuator carriage 161 via linear or rotary joints allowing it to be folded in a compact manner. In FIG. 3, the restocking robot 102 pulls a bin 312 from a shelf 310. In order to do that the linear actuator carriage 161 is moved to a height that makes the extended plate 301 slightly lower than the height of the shelf 311, allowing the robot arm 200 to deploy the end effector of the restocking robot 102 to pull the bin onto the plates 301 and 302 of the transition flap 300.

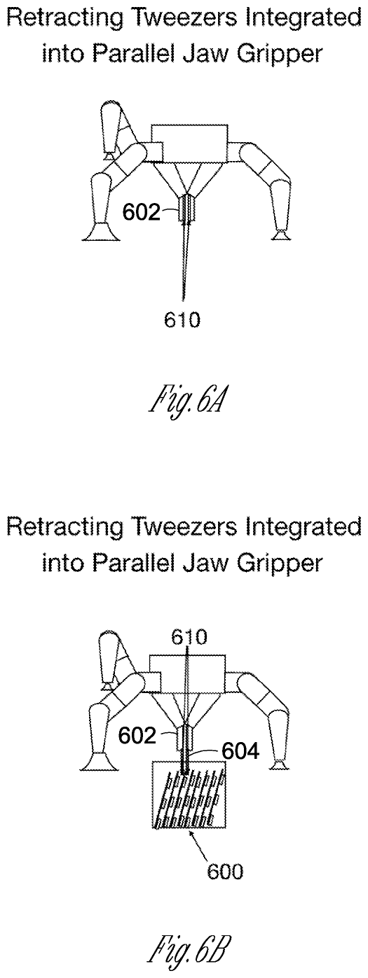

With reference to FIGS. 5A-5B and FIGS. 6A-6B, examples of an end effector 540 of the restocking robot 102 are now described. The successful manipulation and handling of different sizes of medication and/or medical supplies may require the deployment of different types of end effector. The end effector of FIGS. 5A-5B includes suction cups, and more particularly different sizes of suction cups, for handling and manipulating different sizes and/or configurations of packaged medications and medical supplies. For example, large and heavy objects such as IV-bags or boxes may require one or multiple large suction cups (for example, as shown in FIG. 5B), whereas small blisters of medication supplied in blister packs 550 and 560 for example may only require or be successfully handled by a single small suction cup that can fit into the gap between the different pills on a blister pack 550 so as to establish a vacuum to attract and hold the blister pack 550 on the end effector 540. This arrangement is shown for example in the side view of FIG. 5A. As shown in the views of FIGS. 5A-5B, multiple retractable “fingers” 511 are attached to the robot's end effector 540. One or multiple suction cups 520 of the same or different size are mounted at the tip of each finger 511. The fingers 511 can retract or fold upwardly, or unfold and deploy downwardly, as shown using multiple links connected by rotary joints or linear joints. This arrangement allows the restocking robot 102 to select one or multiple suction cups to interact with an object at a time. The restocking robot 102 can also use its multiple suction-cup fingers to pick multiple items at once resulting in a significant productivity gain.

There may however be some item manipulation situations which do not lend themselves to the use of multiple retractable suction cups in a compact form factor. For example, with reference now to FIGS. 6A-6B, the restocking robot 102 may be required to pick up small items such as blisters of medication 600 that are densely packed and stacked vertically (see for example the view of FIG. 6B, e.g. inside an ADC pocket) and that may be impossible or at least very difficult to grasp using a relatively large prehensile gripper such as the parallel jaw gripper 602 of the restocking robot 102, or any form of suction cup for example as described above with reference to FIGS. 5A-5B. To this end, in some examples, the parallel jaw gripper 610 of the restocking robot 102 is provided with retractable tweezers (shown withdrawn at 610 in FIG. 6A) that can be extended (shown extended at 604 in FIG. 6B) and urged together, once extended, by the parallel jaw gripper 602 to grasp small and thin items, such as the vertically stacked blister packs as shown. To extend and retract the tweezers, an electrical or pneumatic linear or rotary motor can be used.

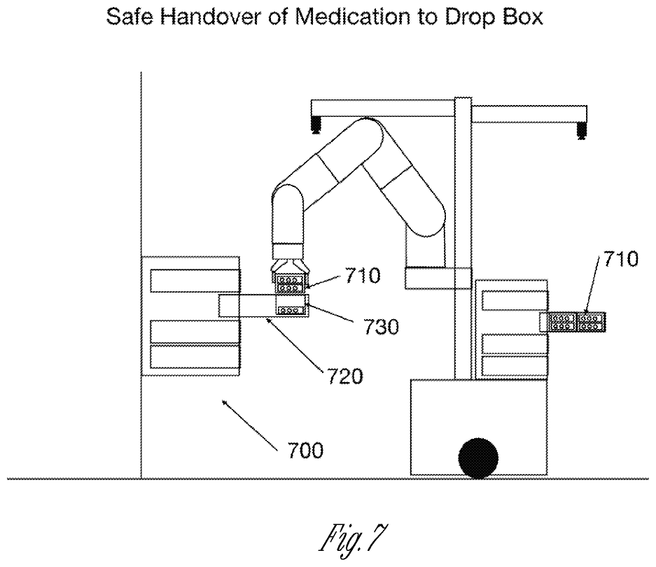

Some examples include a safe handover of medication to a drop box. With reference to FIG. 7, in order to safely transfer medication from the restocking robot 102 to a medication drop box 700 (for example, located on a patient floor or in a nursing unit), the restocking robot 102 can use its robot arm 200 and end effector 540 to take a locked medication box 710 containing the restricted medication from a previously-loaded location in its robot drawer and position the locked box 710 above a drawer 720 of the drop box 700 where the medication can be released from the end effector 540 to fall into a pocket 730 of the drop box drawer 720. In some examples, drop boxes can be accessed by nurses or medical staff via passcode, fingerprint, and so forth. Some examples include a secure transfer between a restocking robot 102 and a drop box through hand-over of locked boxes.

In some example medication restocking methods, a restocking robot 102 pulls bins with medication from a carousel system (for example a carousel system 402 of FIG. 4) or a shelf (for example as shown in FIG. 3) and takes the correct (desired restocking) quantities of medication or medical supplies from these bins and puts them into robot drawers 120 of a robot cabinet 210 previously positioned on a bench 220 located in a central pharmacy of a hospital, clinic, or medical center for example. In some examples, the robot cabinet 210 can be loaded while positioned on the mobile base 100 of the restocking robot 102. As described further above, the robot drawer 120 can have multiple pockets 110 designated to accept different types of medication, or medications assigned to different destinations throughout the hospital, clinic, or center. In the illustrated bench-loading example, once a robot drawer 120 has been loaded with the requisite items (or is otherwise full), the restocking robot 102 loads the robot drawer 120 into the robot cabinet 210 by sliding it from the bench 220 onto the restocking robot 102. In some examples, the robot cabinet 210 includes rollers at the bottom to allow for easy sliding. In some examples, a significant purpose of the bench 220 is to store robot cabinets 210 to allow for additional manual filling of the robot drawers 120 by human staff. In some examples, the robot drawers 120 are part of the robot cabinet 210 and can be pulled open or pushed closed. In some examples, the robot cabinet 210 can be slid from the bench 220 onto the mobile base 100 or vice versa.

The restocking robot 102 takes the loaded robot drawer 120 (held inside the robot cabinet 210) up to an ADC along a restocking route of the restocking robot 102. The restocking robot 102 then logs into the ADC either through an electronic interface or physically by interacting with the ADC (e.g. typing a password using its end effector). Using its controlled robot arm 200 and end effector 540, the restocking robot 102 then begins restocking medication into the ADC from its robot drawer 120. First the restocking robot 102 opens an ADC drawer and a pocket inside the ADC drawer (after unlocking) and then counts the medication that is already inside the pocket and determines an earliest expiration date of the medication. This is done by taking all the existing medication out, scanning the expiration date on each medication using the third scanning zone 114 of the barcode scanner 130. The first scanning zone 108 and/or the second scanning zone 112 may be used in some examples. The restocking robot 102 then places both existing and new medication in the pocket of the ADC. Finally, the restocking robot 102 updates both the counts of the medication as well as a closest (or updated) expiration date in the ADC either electronically or by physically typing the data on the ADC. The same procedure is repeated for every type of medication and every ADC in the hospital. In addition, the restocking robot 102 refills patient-specific drawers or bins in other medication rooms of the hospital, clinic, or center.

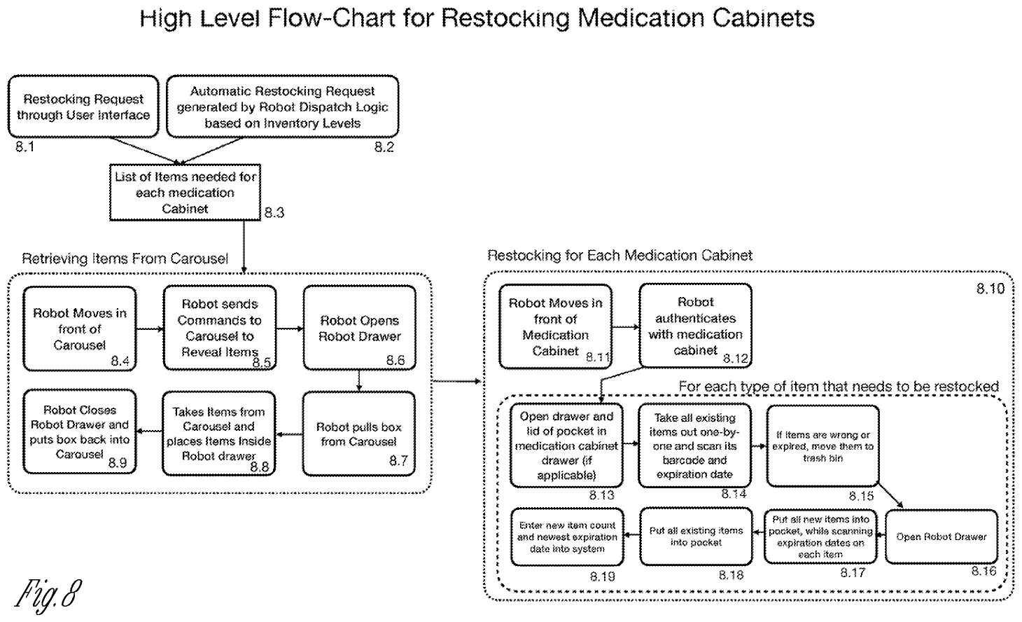

With specific reference to the flow chart of FIG. 8, in operation 8.1 an example restocking process is either triggered by a staff member requesting restocking of particular items for a particular set of medication cabinets or automatically in operation 8.2 by a robot dispatch logic. The manual or automatic restock request may be made via the computer terminal 151 (FIG. 1) or via the onboard or remote controller described above. In some examples, hospital staff can use any computer of the robotic system (described further below) to log into a user-interface to make restock requests, or otherwise monitor, control, or configure the restocking robot 102. The robot dispatch logic considers the inventory levels in each medication cabinet as well as the inventory levels in each carousel (or other storage device) in the central pharmacy and decides when and which restocking robot 102 to command to perform restocking of a particular set of medication cabinets. In operation 8.3, a manual or automatic restocking request may include a list of items to re-up inventory levels at each medication cabinet.

As shown in FIG. 8, subsequent operations may be viewed broadly in two phases: a first phase including retrieving items from a carousel or shelf (for example), and a second phase including restocking a medication cabinet. In the first phase, once a restocking robot 102 has received a restocking request including the list of items from operation 8.3 that need to be restocked into one or more medication cabinets, the restocking robot 102 moves in operation 8.4 in front of the carousel or other storage device to load up. In operation 8.5, the restocking robot 102 commands the carousel to reveal the items that are needed in the list, and in response the carousel moves its internal shelf-layers to expose a box (or bin) holding the requested items. In operation 8.6, the restocking robot 102 opens one of its own robot drawers. In operation 8.7, the restocking robot 102 pulls the box containing the requested items from the carousel, and in operation 8.8 takes each item from the carousel box and places the items inside the opened robot drawer. In operation 8.9, the restocking robot 102 closes the opened robot drawer and pushes the carousel box back into the carousel, and closes the carousel drawer. This sequence is repeated until all items required for a particular restocking run have been retrieved by the restocking robot 102.

In the second phase, in operation 8.11 the restocking robot 102 navigates in front of each applicable medication cabinet and repeats the following sequences of steps, as needed. In operation 8.12, the restocking robot 102 authenticates with the medication cabinet to which it has navigated either electronically (i.e. through Wi-Fi, or other means of computer networks) or by typing a password on a medication cabinet login screen, or by pressing the medication cabinet's fingerprint sensor with its own robot-fingerprint. In operation 8.13, the restocking robot 102 opens a medication cabinet drawer and (if present) opens the lid of the relevant pocket inside the medication cabinet drawer that needs to be restocked. In operation 8.14, the restocking robot 102 takes out all existing items one-by-one scanning each item's barcode and expiration date by placing the item into the robot's scanner, for example using the scanning zone 114 of the scanner 130. Alternative item scanning can be based on RFID. In some examples, some or all items of medical supply are equipped with an RFID tag. In some examples, the ADC drawers are equipped with RFID reader antennas allowing item identification by a scanning of an item's RFID, expiration date, and other pertinent data. In operation 8.15, and based on data contained in lookup up tables or data retrieved from previously scanned items stored in a restocking database, if any incorrect items or expired items are detected the restocking robot 102 places these in a dedicated discard-compartment on the restocking robot 102. The restocking database may be connected to or included in a restocking system described further below with reference to FIG. 9.

In operation 8.16, the restocking robot 102 opens one of its robot drawers holding the required items listed in the restocking request and, in operation 8.17, places the applicable quantities of these into the pocket of the medication cabinet drawer while scanning, as described above, barcodes on the placed items to derive quantity and expiration dates of each placed (restocked) item.

In operation 8.18, the restocking robot 102 puts all existing items that it had taken out earlier back into the pocket of the medication cabinet drawer and, in operation 8.19 enters the applicable item count and newest expiration date into the restocking database either electronically or by typing on the medication cabinet's keyboard. This procedure is repeated for every type of item that needs to be restocked as well as every medication cabinet.

With reference to the software architecture of a restocking system depicted in FIG. 9, from a high level perspective view, the restocking system may be seen to comprise two main sections. A first section is deployed on a hospital's local network 9.1 and includes networked componentry provided on the restocking robot 102 (labeled 9.5 in FIG. 9), an inventory management system 9.4 (including a restocking database and inventory lists 9.28), one or more medication cabinets 9.29, one or more carousels 9.30, and a system user interface 9.6 for hospital staff. A second section of the restocking system is located on the public internet and includes a secure cloud 9.18 and a control center 9.22. The hospital's local network and the public internet are separated by a fire-wall 9.2.

When the inventory level in a medication cabinet 9.29 becomes low, the cabinet 9.29 sends its inventory list 9.31 to the inventory management system 9.4. The inventory management system compiles an inventory list for all medications 9.28. At the same time or over a similar period, the carousel 9.30 periodically sends its updated inventory list 9.32 to the inventory management system 9.4.

The inventory management system synchronizes its inventory list with the secure cloud 9.18, 9.21. When the inventory runs low in a particular medication cabinet, the robot dispatch logic 9.19 decides which restocking robot 102 to send to restock that particular medication cabinet. The robot dispatch logic sends a message to a particular restocking robot 102 (9.5) through an encrypted interface 9.25 (such an encrypted REST API) containing information on which cabinet and which items need to be restocked. Alternatively, restocking robots 102 can be dispatched manually by the hospital staff through the user interface 9.6.

Residing and operating on networked componentry on the selected restocking robot 102, a high-level task planner 9.7 determines which high level task needs to be performed next. For example, the high-level planner 9.7 commands the restocking robot 102 to move in front of the carousel 9.30 to retrieve items. The high-level task planner 9.7 has access to a hospital map that includes the locations of all carousels, medication cabinets, elevators, and any other relevant objects, and directly sends navigation goals to a robot base planner 9.9. A robot base for which the navigation goals are planned may for example be the mobile base 100 of the restocking robot 102 depicted and described with reference to FIG. 1. The robot base planner 9.9 obtains a map and the location of the selected restocking robot 102 from a mapping and localization module 9.8 and uses this information to find a path leading to one of the navigation goals. The navigation path is then sent to a robot base driver 9.10 which includes a control system for following the desired path.

Once the restocking robot 102 arrives at the destination, e.g. in front of a medication cabinet, the high-level task planner 9.7 communicates with the cabinet 9.29 either electronically 9.32 or by sending instructions enabling the end effector of the restocking robot 102 to type on a cabinet screen 9.32. The high-level task planner 9.7 selects an appropriate AI-model for performing a sequence of manipulation steps that successfully complete the restocking task. For example, the high-level task planner 9.7 first activates a drawer opening AI-model 9.13 which receives camera images from camera drivers 9.11. The drawer opening AI-model provides coordinates to a robot arm motion planning module 9.16 which finds or determines a sequence of joint angles that make the robot arm 200 and end effector 540 successfully complete the restocking task. Finally, a robot arm driver 9.15 executes the required motion.

Once the relevant medication cabinet drawers are opened, the high-level task planner 9.7 activates a picking AI-model 9.14 to grasp items via suction cups (for example as described above) or via prehensile grippers (such as parallel jaw grippers and tweezers as described above). The picking AI-model 9.14 finds coordinates and orientations in an RGB-Depth image where objects can be successfully picked up. The picking coordinates are transformed into robot-world-coordinates using an image to world transformation resulting from a camera calibration 9.17. The target world-coordinates describe in machine language where the robot's end effector needs to move in 3D space to successfully pick up an object, and are then passed into a robot arm and end effector motion planner 9.16 which finds an appropriate collision-free path and executes it via a robot arm and end effector driver 9.15. Alternatively, an AI model (e.g. for door opening) 9.12 can be used that directly outputs desired end effector positions and orientations (or end effector velocities) and bypasses the arm motion planner.

In some examples, human staff in the control center 9.22 monitor the restocking robots 102 and can take over control by teleoperating the robots 9.23 in unexpected circumstances. For example, when a drawer is stuck, a human operator can assess the situation and try to open the drawer by manually controlling the robot arm.

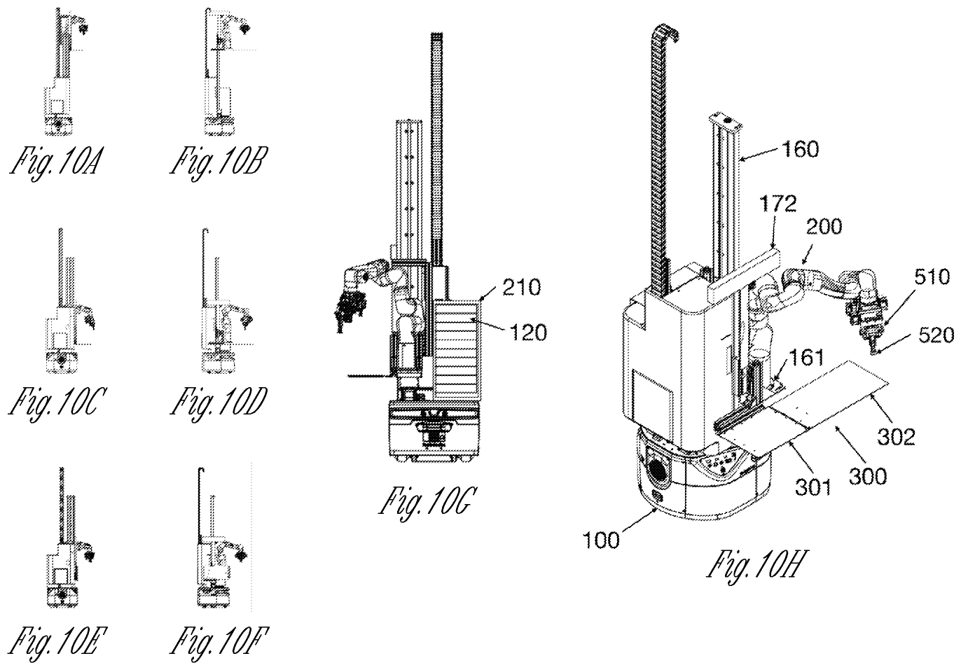

In FIGS. 10A-10H, the illustration of FIG. 10H provides an isometric view of the restocking robot 102 showing the vertical linear actuator 160 and a part of the linear actuator carriage 161. The flap 300 is fully unfolded with plates 301 and 302 extended outward on the right side. The camera beam 172 (here shown as a box) contains a linear actuator that moves the camera over the flap or a medication cabinet. FIG. 10G provides a front view of the restocking robot 102 showing at 210 the robot cabinet equipped with robot drawers 120. FIGS. 10A-10B respectively show the rear and side view of the restocking robot 102 when the vertical linear actuator is driven to its maximum height, whereas FIGS. 10C-10D show the same with the vertical linear actuator driven to its minimum height. FIGS. 10E-10F show the flap 300 fully folded. The flap 300 can either be folded by the robot arm 200 or using actuators that are integrated into the flap 300.

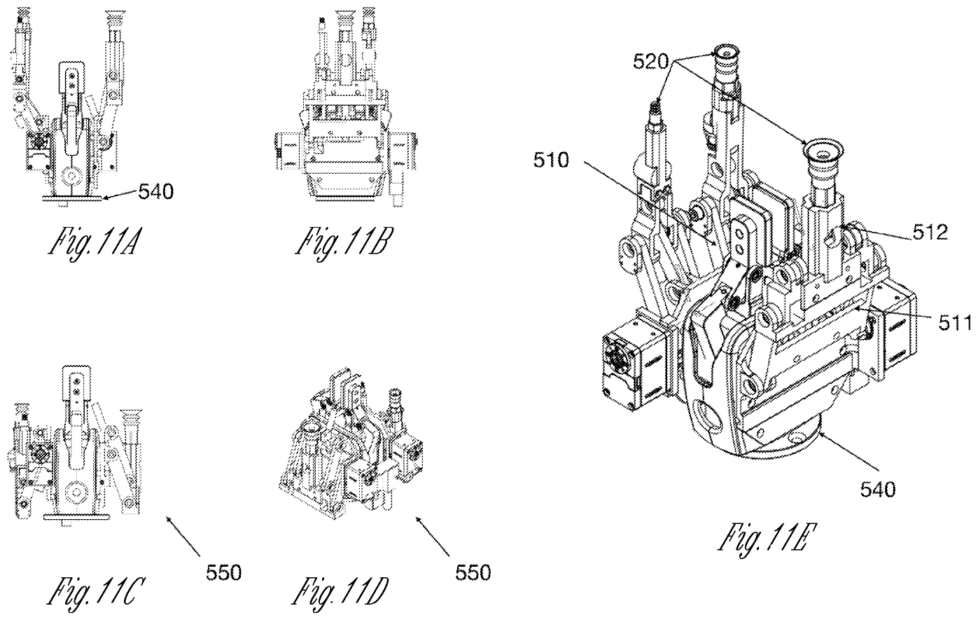

With reference to FIGS. 11A-11E, the illustrations in FIG. 11A, FIG. 11B and FIG. 11E show the multi-finger end effector 540 with all fingers fully extended, whereas the views of FIG. 11C and FIG. 11D show all fingers in a fully retracted state. Each finger is equipped with a different size of suction cup 520. The base of the end effector 540 is mounted to the robot arm, as described above for example. In the illustrated example, every finger comprises a parallelogram of links. The part that attaches to the suction cup 512 always maintains its orientation with respect to the base of the end effector 540. In some examples, the fingers can retract using multiple links connected by rotary joints or linear joints, allowing the robot to select one or multiple suction cups to interact with an object at a time.

Some examples of a robotic system herein relate to restocking medication trays. On a single day a mid-sized (400 bed) hospital may need to assemble roughly 80 trays of medication, used for anesthesia or for crash carts for example. If done by human technicians, this is a very error prone task since it is easy to overlook expired medications or a medication that has ended up in an incorrect tray-pocket. Unfortunately surgeons and other medical staff might overlook an erroneously placed medication in a medication tray and inadvertently administer incorrect or expired medication with potentially fatal consequences. A restocking robot 102 as described above can also be used to replenish medication and fully validate medication trays.

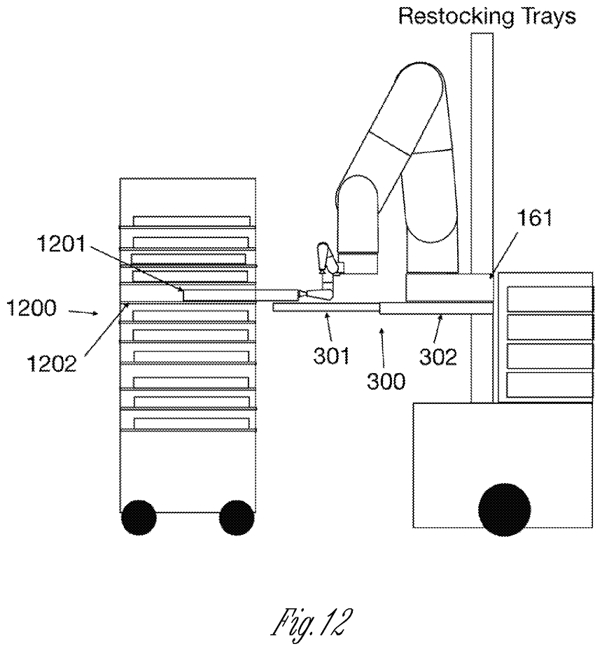

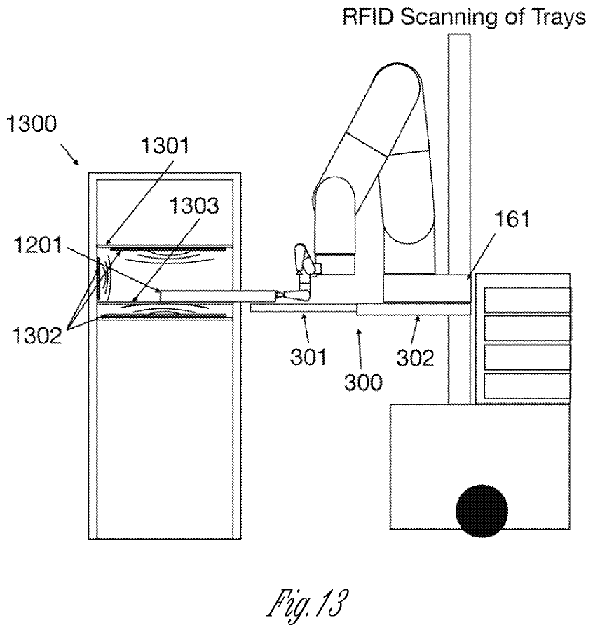

With reference to FIG. 12 and FIG. 13, the base 100 of the restocking robot 102 is controlled to drive in front of medication tray cart 1200 which contains a number of levels 1202 each with at least one medication tray 1201. The restocking robot 102 then unfolds its transition flap 301 and using its robot arm and appropriate end effector pulls a tray 1201 from the cart onto the transition flap 301. In order for the restocking robot 102 to register each item in the tray it uses a combination of RFID scanning and AI-based computer vision.

For RFID scanning, with the tray 1201 placed on its flap 301, the restocking robot 102 drives in front of an RFID scanning device 1300, also referred to as “RFID oven”, opens the oven's door and pushes the tray 1201 inside. The function of the oven 1300 is to shield radio signals and to allow RFID reader antennas 1302 only to pick up signals from items on the tray 1201. The oven 1300 is equipped with radio-signal-reflective material 1301 that fully encloses the antennas 1302 and the tray 1201. Inside the oven 1300, the tray 1201 rests on an RF-signal transparent material 1303 to allow the lower antenna on the bottom of the oven cavity to reach the tray 1201. Each item on the tray is equipped with an RFID tag and is scanned (read) accordingly.

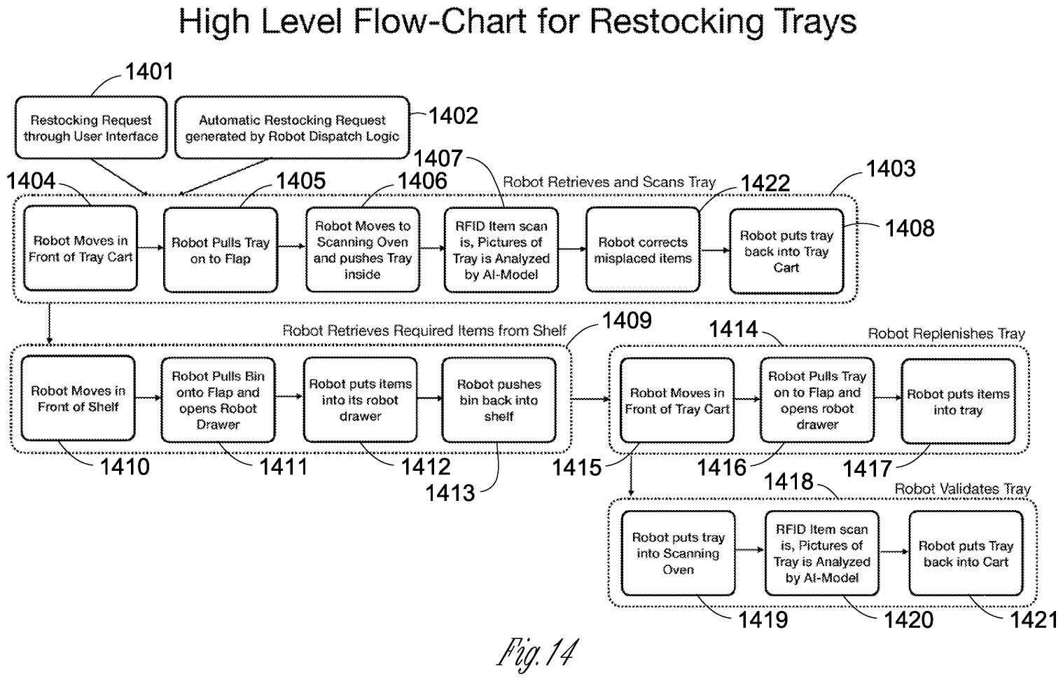

FIG. 14 illustrates a high level flow-chart of a method of restocking medication trays, in accordance with an example method. After the trays 1201 have been used (e.g. in the operating rooms) a medication tray cart 1200 carrying the trays 1201 is placed in a working area of the restocking robot 102. Then, in operation 1401, a pharmacy technician makes a restocking request through a user interface (as described above for example) or restocking can be triggered automatically in operation 1402 by the robot dispatch logic (potentially implemented in operation 9.19 in the secure cloud).

As an initial step at the restocking robot 102, the restocking robot 102 retrieves a tray 1201 and scans its contents in operation 1403. To do this, in operation 1404, the restocking robot 102 first moves in front of the tray cart 1200, in operation 1405 pulls the tray onto the transition flap 300 of the restocking robot 102, and then in operation 1406 moves the tray 1201 into the RFID scanning oven 1300, and closes the oven's door. After RFID scanning is complete the restocking robot 102 takes the tray 1201 out of the oven 1300, and takes a picture of the tray 1201 using one of its cameras (see for example, FIG. 1.). In operation 1407, the picture is analyzed by an AI-model to classify the identity of each item. The robotic system combines data from the RFID scanning and the AI-model results to determine which items are missing, how many need to be restocked and if any items are placed into wrong pockets and need to be corrected. In operation 1422, in case items need to be corrected, the restocking robot 102 automatically places the respective items into the correct pockets of the tray 1201. If items are detected that do not belong to the tray 1201 they are automatically removed by the restocking robot 102. In operation 1408, the restocking robot 102 places the tray 1201 back into the tray cart 1200.

The next stage is for the restocking robot 102 to retrieve the required items from shelves. For that, in operation 1410 the restocking robot 102 moves in front of the appropriate shelf, unfolds its transition flap 300 and in operation 1411 pulls a shelf-bin onto its transition flap 300, opens one of the robot drawers 120, and in operation 1412 puts the required items into its robot drawer 120. Next, in operation 1413 the restocking robot 102 pushes the bin back into the shelf. This procedure is repeated until all required items are retrieved.

The next stage is for the restocking robot 102 to replenish a tray 1201. In operation 1415, the restocking robot 102 moves back to the tray cart 1200 to pull, in operation 1416, the relevant tray 1201 onto the transition flap 300 again and to open its robot drawer 120. The robot then puts the items from the robot drawer 120 into the tray 1201. This procedure is repeated for every item until the tray 1201 is fully restocked.

In a final validation stage 1418, the restocking robot 102 performs an additional validation of the tray by, in operation 1419, putting the tray 1201 into the scanning oven 1300 again. In operation 1420, the same RFID scanning and AI-model validation procedure as described above is repeated. Once a tray 1201 is fully validated it is put back into the tray cart 1200 and ready for the next procedure.

Optionally a pharmacist can view the pictures taken of the tray and perform an additional validation and approval step.

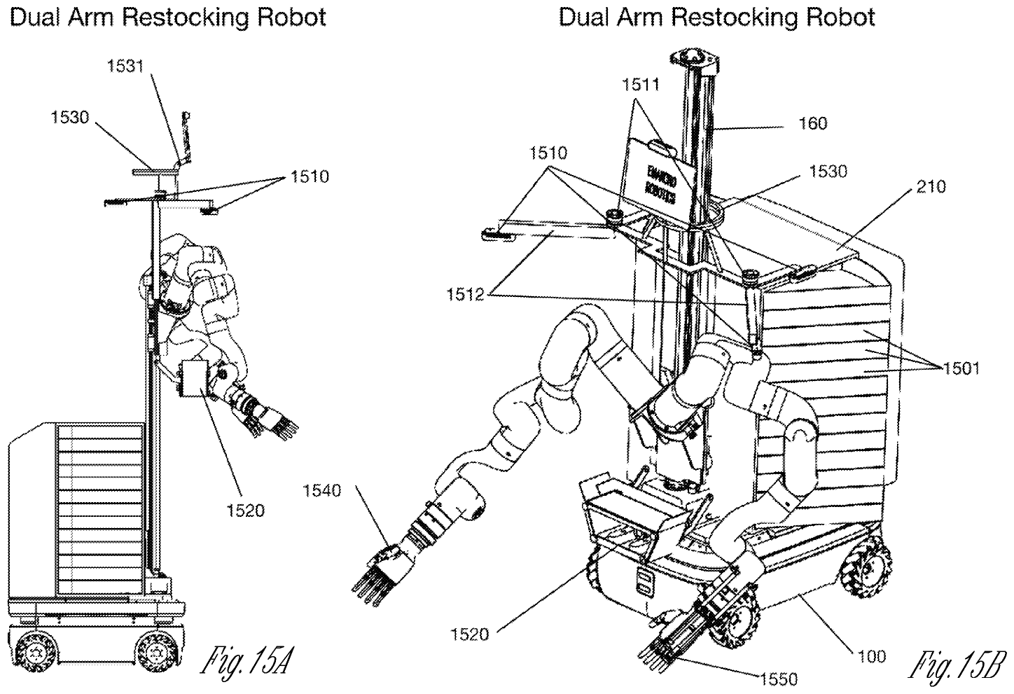

FIGS. 15A-15B show pictorial views of a two-arm version of an example restocking robot. The robot includes rotary drawers 1501 instead of linear drawers. The rotary drawers 1501 may have an advantage of allowing restocking items to be brought closer to a restocking destination, reducing travel times for the arm, and increasing overall efficiency. The robot arms are equipped with robot hands 1540 and linearly retractable suction fingers are attached to the back of the hands 1540. That way the robot can use its hand or suction cups interchangeably.

In some examples, the robot is also equipped with a barcode scanner 1520 at the front of the robot. In some examples, the robot is equipped with camera beams 1512 that can be rotated using rotary actuators 1511 allowing the robot to bring cameras 1510 into position to provide an optimal view of a medication cabinet from above. In some examples, the camera beams 1512 can fold backwards during travel.

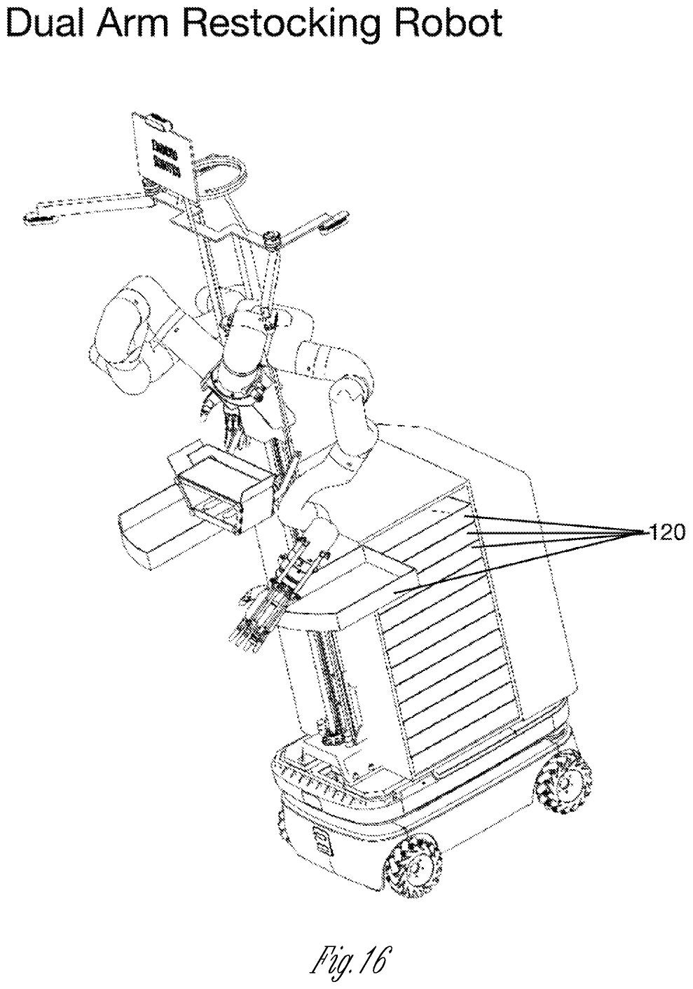

FIG. 16 shows the top rotary drawers provided on both sides of the robot opened in a fully extended, restocking position. All the lower drawers relative to the top drawers, are shown in a closed position.

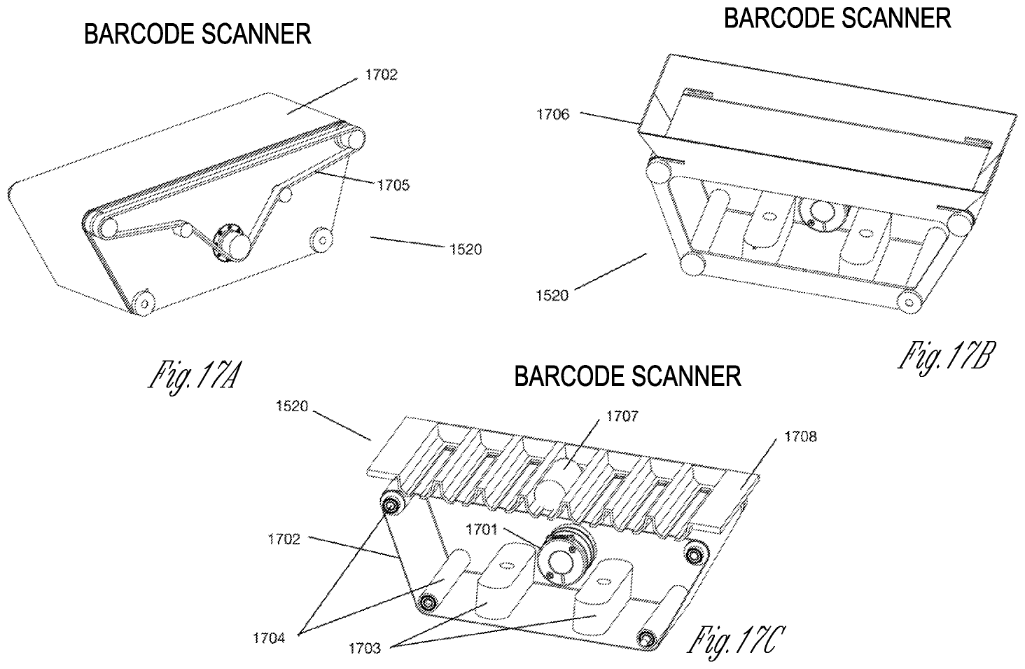

FIGS. 17A-17C illustrate a barcode scanner 1520 that comprises a transparent conveyor belt 1702 that allows rotating a vial (for example) or any cylindrical object 1707 around its axis so that the camera 1703, or another camera viewing from above can capture the barcode or any other information on the item. A vial holder or tray 1708 ensures that the vial stays fixed while frictional engagement with the moving conveyor belt causes the vial to rotate around its axis. In one example, the conveyor belt is actuated by a motor 1701 driven by a timing belt 1705.

A restocking robot 102 and more generally a restocking robotic system including a fleet of restocking robots 102 as herein described can provide several benefits. These benefits can include elimination or reduction of medication theft, the reliable provision of a full variety of medication and supplies, elimination, or reduction of medication expiration, a full or improved accuracy in delivery of medications and medical supplies, and labor savings.

While the above is a detailed description of the example embodiments of the inventive subject matter, various alternatives, modifications, and equivalents may be used. Therefore, the above description should not be taken as limiting the scope of the inventive subject matter which is defined by the appended claims.

What is claimed is:

1. A restocking robot comprising:
a mobile base controllable to navigate to an inventory unit at a restocking location;
a robot cabinet supported by the mobile base, the robot cabinet including a receptacle for holding a restocking item for the inventory unit;
a robot arm controllable to engage with and open the receptacle of the robot cabinet and retrieve therefrom a restocking item for restocking the inventory unit; and
the robot arm including an end effector mounted to the robot arm, wherein the end effector is controllable to move the restocking item retrieved from the receptacle of the robot cabinet into the inventory unit at the restocking location.

2. The restocking robot of claim 1, wherein the receptacle in the robot cabinet includes a robot drawer movable in the robot cabinet to be opened and closed by the restocking robot.

3. The restocking robot of claim 1, further comprising a vertical linear actuator supported by the mobile base.

4. The restocking robot of claim 3, wherein the robot arm is supported by the vertical linear actuator.

5. The restocking robot of claim 1, wherein the mobile base is motorized and includes a sensor for localization and navigation of the restocking robot to the inventory unit at the restocking location.

6. The restocking robot of claim 1, wherein the end effector includes an array of robot fingers and/or a prehensile gripper controllable to grasp the restocking item.

7. The restocking robot of claim 3, wherein the robot arm comprises a series of interconnected links, wherein a base link of the robot arm is connected to the vertical linear actuator, and wherein each interconnected link of the robot arm is controllable either to rotate about a longitudinal axis of the interconnected link with respect to an adjacent or another link in the robot arm, or to adjust a relative or angular position of the link with respect to an adjacent or another link in the robot arm.

8. The restocking robot of claim 6, wherein the array of robot fingers includes at least one robot finger provided with a suction cup to hold, under application of a vacuum, the restocking item.

9. The restocking robot of claim 1, wherein the inventory unit comprises a medication cabinet including a medication cabinet drawer, and wherein the robot arm is controllable to open and close the medication cabinet drawer.

10. The restocking robot of claim 9, wherein the robot arm is controllable to move the retrieved restocking item to a medication cabinet drawer prior opened by the robot arm.

11. The restocking robot of claim 10, wherein the medication cabinet drawer includes a pocket, the pocket associated with a specific restocking item, and wherein the robot arm is controllable to restock the pocket with the specific restocking item associated with the pocket.

12. The restocking robot of claim 9, wherein the medication cabinet is assigned as a navigation target for the mobile base of the restocking robot.

13. The restocking robot of claim 6, wherein the prehensile gripper includes a parallel jaw gripper including a pair of retractable tweezers.

14. The restocking robot of claim 8, wherein at least one suction cup provided on the array of robot fingers is sized to fit between pills in a blister pack.

15. The restocking robot of claim 1, wherein the robot cabinet is removable from the restocking robot, and wherein the robot arm is further controllable to place the removable robot cabinet on a support surface adjacent the restocking robot.

16. The restocking robot of claim 1, further comprising at least one scanning camera to scan or identify one or more of a barcode, a labelled medication, an item of medical supply, an expiry date, or another item of data borne on the restocking item.

17. The restocking robot of claim 16, wherein the at least one scanning camera is mounted on a camera beam, the camera beam being adjustable to reposition the at least one scanning camera to adjust a scanning zone of the at least one camera.

18. The restocking robot of claim 16, wherein the at least one scanning camera includes an array of scanning cameras defining at least one scanning zone for the restocking robot.

19. The restocking robot of claim 18, wherein the at least one scanning zone includes overlapping fields of view of the at least one scanning camera.

20. The restocking robot of claim 1, further comprising an actuator to transfer or slide the robot cabinet from a transport position on the mobile base to a restocking position of the robot cabinet on a table or bench.

21. The restocking robot of claim 1, further comprising a transition flap to support an item pulled by the restocking robot from a shelf, carousel, or a table.

22. The restocking robot of claim 21, wherein the transition flap is foldable under autonomous action of the robot arm, or under the action of one more multiple actuators.

23. The restocking robot of claim 21, wherein the transition flap is extendible under autonomous action of the robot arm, or self-extendible under action of a motor.

24. The restocking robot of claim 21, wherein the transition flap is mounted on a vertical linear actuator and is controllable to adjust a vertical height of the transition flap.

25. A method of restocking an inventory unit, the method including:
providing a restocking robot, the restocking robot comprising:
a mobile base controllable to navigate to the inventory unit at a restocking location;
a robot cabinet supported by the mobile base, the robot cabinet including a receptacle;
a robot arm controllable to engage with and open the receptacle of the robot cabinet and retrieve therefrom a restocking item for restocking the inventory unit; and
the robot arm including an end effector controllable to move the restocking item retrieved from the receptacle of the robot cabinet into the inventory unit at the restocking location;
directing or configuring the restocking robot to move to the restocking location; and
directing or configuring the end effector to move the retrieved restocking item into the inventory unit.

26. A method of restocking an inventory unit, the method comprising:
providing a restocking robot, the restocking robot including a mobile base, a robot arm, an end effector, and a robot drawer included in a robot cabinet supported on the mobile base;
directing or configuring the restocking robot to navigate to a carousel system supplying items of medication or medical supply;
directing or configuring the restocking robot to pull a bin containing an item of medication or medical supply from the carousel system;
directing or configuring the restocking robot to take a desired quantity of the item of medication or medical supply from the bin and place the desired quantity of the item of medication or medical supply into the robot drawer;
directing or configuring the restocking robot to close or load the robot drawer into the robot cabinet;
directing or configuring the restocking robot to navigate along a restocking route to the inventory unit;
directing or configuring the restocking robot to log into or authenticate with the inventory unit;
directing or configuring the restocking robot to open or a drawer of the inventory unit; and
directing or configuring the restocking robot to restock the drawer of the inventory unit with the desired quantity of the item of medication or medical supply.

27. A method of restocking medication trays, the method comprising:
providing a restocking robot, the restocking robot including a mobile base, a robot arm, an end effector, a scanning camera, a transition flap, and a robot drawer included in a robot cabinet supported on the mobile base;
receiving a request to restock a medication tray carried in a medication tray cart;
moving the restocking robot adjacent the medication tray cart;
directing the restocking robot to pull the medication tray onto the transition flap of the restocking robot;
directing the restocking robot to place the pulled medication tray into an RFID scanning device;
directing the RFID scanning device to scan contents of the medication tray placed therein;
after RFID scanning, directing the restocking robot to remove the medication tray from the RFID scanning device;
directing the scanning camera of the restocking robot to take a picture of the contents of the medication tray to generate tray content data;
analyzing, by a trained AI-model, the tray content data to determine an identity of items in the contents of the medication tray;
based at least on the received restock request, combining data generated by the RFID scanning and trained AI-model analysis to determine items missing from or incorrectly present on the medication tray;
directing the restocking robot to add missing items to the medication tray, or remove items incorrectly present on the medication tray; and
directing the restocking robot to place the medication tray back into the medication tray cart.
